(19) United States
(12) Patent Application Publication
(10) Pub. No.: US 2022/0021863 A1
(43) Pub. Date: Jan. 20, 2022

(54) METHODS AND SYSTEMS FOR FACILITATING POPULATION OF A VIRTUAL SPACE AROUND A 2D CONTENT

(71) Applicant: Chad Lee, Copperton, UT (US)

(72) Inventor: Chad Lee, Copperton, UT (US)

(21) Appl. No.: 17/364,536

(22) Filed: Jun. 30, 2021

Related U.S. Application Data
(60) Provisional application No. 63/051,605, filed on Jul. 14, 2020.

(51) Int. Cl. H04N 13/156; H04N 21/81; H04N 13/167

(52) U.S. Cl. CPC H04N 13/156; H04N 13/167; H04N 21/816; H04N 21/8146

(57) ABSTRACT

Disclosed herein is a method for facilitating population of a virtual space around a 2D content. Accordingly, the method may include receiving, using a communication device, the 2D content from an external device. Further, the method may include analyzing, using a processing device, the 2D content. Further, the method may include identifying, using the processing device, a cue in the 2D content based on the analyzing. Further, the method may include generating, using the processing device, an additional content for the 2D content based on the at least one cue. Further, the method may include synchronizing, using the processing device, the additional content with the 2D content based on the generating. Further, the method may include storing, using a storage device, the at least one additional content.

The current application claims a priority to the U.S. Provisional Patent application Ser. No. 63/051,605 filed on Jul. 14, 2020.

### FIELD OF THE INVENTION

Generally, the present disclosure relates to the field of data processing. More specifically, the present disclosure relates to methods and systems for facilitating population of a virtual space around a 2D content.

### BACKGROUND OF THE INVENTION

Consuming media content has never been easier. Individuals are now able to watch television at high resolutions. Further, television shows and movies may now be watched with ease on the Internet using streaming websites. However, most of the media content, including movies and television shows are only available in the 2D format. However, individuals still have to go to movie theaters to view movies releasing in digital 3D to get a more immersive experience. Further, current technologies do not make existing 2D content more interactive. Further, current technologies do not add special effects to make the existing 2D content more immersive. Furthermore, the current technologies do not allow social interaction between individuals while watching Virtual Reality (VR) content. Further, existing systems do not allow individuals to interact with other individuals through multiplayer games that may be specific to the content that the individuals may be viewing. Further, existing systems to facilitate the consumption of VR and immersive content do not allow individuals to join the other individuals that may be consuming the same content from the same source and interact with each other.

Therefore, there is a need for improved methods and systems for facilitating population of a virtual space around a 2D content that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating population of a virtual space around a 2D content, in accordance with some embodiments. Accordingly, the method may include receiving, using a communication device, the 2D content from at least one external device. Further, the method may include analyzing, using a processing device, the 2D content. Further, the method may include identifying, using the processing device, at least one cue in the 2D content based on the analyzing. Further, the method may include generating, using the processing device, at least one additional content for the 2D content based on the at least one cue. Further, the at least one additional content populates the virtual space around the 2D content. Further, the method may include synchronizing, using the processing device, the at least one additional content with the 2D content based on the generating. Further, the at least one additional content may be synchronously presentable with the 2D content based on the synchronizing Further, the method may include storing, using a storage device, the at least one additional content.

Further disclosed herein is a system for facilitating population of a virtual space around a 2D content, in accordance with some embodiments. Accordingly, the system may include a communication device configured for receiving the 2D content from at least one external device. Further, the system may include a processing device communicatively coupled with the communication device. Further, the processing device may be configured for analyzing the 2D content. Further, the processing device may be configured for identifying at least one cue in the 2D content based on the analyzing. Further, the processing device may be configured for generating at least one additional content for the 2D content based on the at least one cue. Further, the at least one additional content populates the virtual space around the 2D content. Further, the processing device may be configured for synchronizing the at least one additional content with the 2D content based on the generating. Further, the at least one additional content may be synchronously presentable with the 2D content based on the synchronizing Further, the system may include a storage device communicatively coupled with the processing device. Further, the storage device may be configured for storing the at least one additional content.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating population of a virtual space around a 2D content, in accordance with some embodiments.

FIG. 3 is a flowchart of a method for facilitating population of a virtual space around a 2D content, in accordance with some embodiments.

FIG. 4 is a flowchart of a method for analyzing at least one content element for facilitating the population of the virtual space around the 2D content, in accordance with some embodiments.

FIG. 5 is a flowchart of a method for positioning the at least one layer in the virtual space around the 2D content for facilitating the population of the virtual space around the 2D content, in accordance with some embodiments.

FIG. 6 is a flowchart of a method for transitioning at least one interactive object for facilitating the population of the virtual space around the 2D content, in accordance with some embodiments.

FIG. 7 is a flowchart of a method to facilitate population of virtual space around a 2D video, in accordance with some embodiments.

FIG. 8 is an illustration of the layers generated by the disclosed system to populate the virtual space around a 2D video, in accordance with some embodiments.

FIG. 9 is a schematic of a system to facilitate the population of virtual space around a 2D video, in accordance with some embodiments.

FIG. 10 illustrates a screenshot of the movie “SpongeBob SquarePants” with additional content, in accordance with some embodiments.

FIG. 11 illustrates a screenshot of the movie “The Hateful Eight” with additional content, in accordance with some embodiments.

FIG. 12 illustrates a screenshot of the movie “Life of Pi” with additional content, in accordance with some embodiments.

FIG. 13 illustrates a screenshot of a 2D content with additional content, in accordance with some embodiments.

FIG. 14 illustrates a screenshot of the movie “Scarface” with additional content, in accordance with some embodiments.

FIG. 15 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating population of a virtual space around a 2D content, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information.

Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods and systems for facilitating population of a virtual space around a 2D content. Further, the disclosed system (such as 2Dplus) may facilitate the population of virtual space around a 2D video. Further, 2Dplus may include a platform to facilitate viewing of enhanced VR movies and content through VR headsets. Further, the 2Dplus Platform may add data layers on top of a streaming 2D video in real-time for viewing in Virtual Reality (VR). The data layers may be additional visual effects, social and 3d environments to be displayed on top of the 2D video at designated times. The 2D plus pattern may include a 2Dplus library, the 2D video, and a .2DP sequence file. Further, the 2Dplus platform may analyze each 2D video to determine the content that may be needed from the 2DP library and may “sequence” the 2D video. Further, the sequencing procedure may create a separate data (log) file that may sequence a particular 2D video. For instance, in non-linear video editing terms, the 2D plus platform may add multiple layers on top of the 2D video at specific time points and may identify assets from the 2DP library that may be needed while playing the 2D video. Further, after sequencing the 2D video, a .2DP sequence file, which may be a small data file that contains all the sequenced information, may be created. The .2DP files and a .2DP library that contains all the assets used by every 2D video in the system may be stored on servers. Further, when a user may select a 2D video to play from the 2Dplus platform, the .2DP file may be loaded initially, followed by the 2D video. The 2Dplus platform may display the 3D environment, and social information associated with the movie for a particular user, on top of the 2D video. While the 2D video may be streaming, the 2Dplus platform may populate the 2D video with assets such as FX, changing backgrounds, and social elements from the library at the appropriate time to display along with the social inputs of the user. Further, the 2D video may not be stored on the 2Dplus platform. Further, the 2D video may not be embedded with content from the 2Dplus platform. The 2D video may be streamed directly from external databases. The 2Dplus platform may only generate the additional content, and populate the 2D video with the content in real-time while the 2D video may be streamed. Further, 2D videos may be analyzed to create the .2DP sequence file. The process of analysis may be manual. Alternatively, the process of analysis of 2D videos may be automated. The 2D video may be analyzed by image analysis and sound analysis. Further, image processing may be performed, and the sounds in the 2D video may be analyzed to determine the exact setting, and environment of the 2D video, along with the objects being used. For instance, a timeline may be created of special events such as explosions and firefights, along with all other events happening in the 2D video. Further, after the creation of the timeline, the 2D video may be populated with additional visual content from the .2DP file to enhance the viewing experience of the user.

In an embodiment, the disclosed system may facilitate the population of virtual space around a 2D video. Further, the 2D video may be viewed using a VR headset. The elements that may populate the virtual space may make the virtual space around the 2D video immersive, and even interactive. The disclosed system may include at least one user device (or user device). The user device may include a mobile device such as, but not limited to, a smartphone, or a computer tablet. Further, the user device may include a communication device configured to communicate over a communication network such as, but not limited to, a cellular network, a satellite network, a personal area network, Bluetooth, Internet, and so on. Further, the disclosed system may allow users to register and create user profiles. Further, the system may facilitate the population of the virtual space around a 2D video. Further, the elements that may be used to populate the virtual space may make the virtual space more immersive. The user device may be used by an individual to access the 2D video from an external database, such as a streaming service like Netflix ®. Alternatively, the user device may store the 2D video in memory of the user device. Further, the disclosed system may be communicatively coupled to a VR headset to play the 2D video and additional content populated by the disclosed system around the 2D video. The VR headset may include a display to display the 2D video and additional content. Further, the VR headset may include an audio output device, such as but not limited to a speaker, or a pair of headphones, or earphones. Further, the VR headset may include a communication device configured to communicate over a communication network such as, but not limited to, a cellular network, a satellite network, a personal area network, Bluetooth, Internet, and so on. Further, the VR headset may include a user interface to allow the user to communicate and interact with the content that may be displayed on the display. Further, the VR headset may include a processor. The processor may process the inputs that may be received from the user through a user interface. The 2D video may include a movie or a television show that the user may want to view through the VR headset.

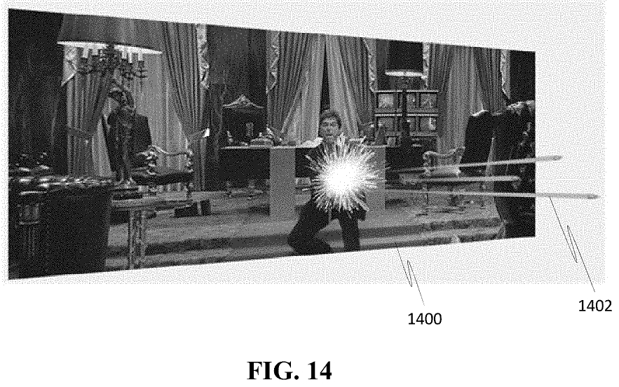

The user may select the 2D video from the user device. Further, the disclosed system may be configured for analyzing the 2D video. The analyzing of the 2D video may include image analysis of the 2D video that may be performed on the frames of the 2D video. The analyzing of the 2D video may include sound analysis, where all the sounds in the 2D video may be analyzed. Upon analyzing the 2D video, the disclosed system may populate the virtual area surrounding the 2D video with additional content relevant to the 2D video. For instance, if the 2D video is a movie, the additional content may include changes in environment and lighting depending on the scene that may be playing in the movie. Further, the additional content may include extensions of the sets of the movie that may make the movie more immersive. Further, the disclosed system may add additional special effects (or special effects) and 3D elements to the movie being played. For instance, as shown in FIG. 14, bullets may be seen shot at the user during a shootout scene, and glass may be seen exploding off the screen during a crash. Image and audio processing may trigger the special effects. For instance, the disclosed system may recognize the sound of explosions, and gunshots, and may populate the virtual space around the movie with special effects. Further, the additional content may include storyline reminder videos, pop-ups containing facts, and mini-games, for example, trivia about the movie, favorite show. The additional content may be toggled to be turned on or off.

Further, the disclosed system may populate the virtual space around the 2D video to allow social interaction between users through user profiles. Further, the user may choose to add other users as friends, that may or may not be acknowledged by the other users. For example, if a first user wishes to add a second user as a friend, the first user may choose to send a request to the second user. Further, the second user may choose to accept or ignore the request.

Further, the disclosed system may create additional layers of content, that may be played along with existing 2D content such as movies and television shows, without making any changes to or adding data to the existing content.

Further, the disclosed system may allow the user to view all users that may be added as friends depending on the privacy settings of the profiles. Further, the user may alter privacy settings to allow or restrict potential users who may want to view profiles associated with an account operated by the user. For instance, the user may edit the profile settings to allow friends (or other users) to view the profile and the data associated with the user. Further, the disclosed system may allow the users to view the 2D videos watched previously or currently being watched by friends. Further, the disclosed system may allow the user may watch a 2D video in a VR environment. The users may watch a 2D video sourced from a database. Further, the disclosed system may allow the users watching the 2D video that may be sourced from the database to interact with each other. The interaction may be through various means. For instance, the users may interact through instant messages, video calls, or audio calls. Further, the users may view online avatars of the users that may be watching the 2D video sourced from the same source. The users may interact with each other through interactive emotes for instance laugh, cry, or scared. The disclosed system may populate the virtual environment with interactive objects that the users may interact with. For instance, the users may throw virtual popcorn at other users. Further, if a user leaves the virtual environment, other users may see a “walkout” or teleport effect. Further, the disclosed system may allow users to watch live events using the VR headset. For instance, the disclosed system may allow the users to view the streaming of a football match live. The disclosed system may populate the VR environment with effects simulating a football stadium, and the users may be able to the football match live with fans located worldwide. The disclosed system may allow the users to add users viewing the same event as friends. Further, the users may make friends and engage in conversation through messages, audio, or video calls while watching an event.

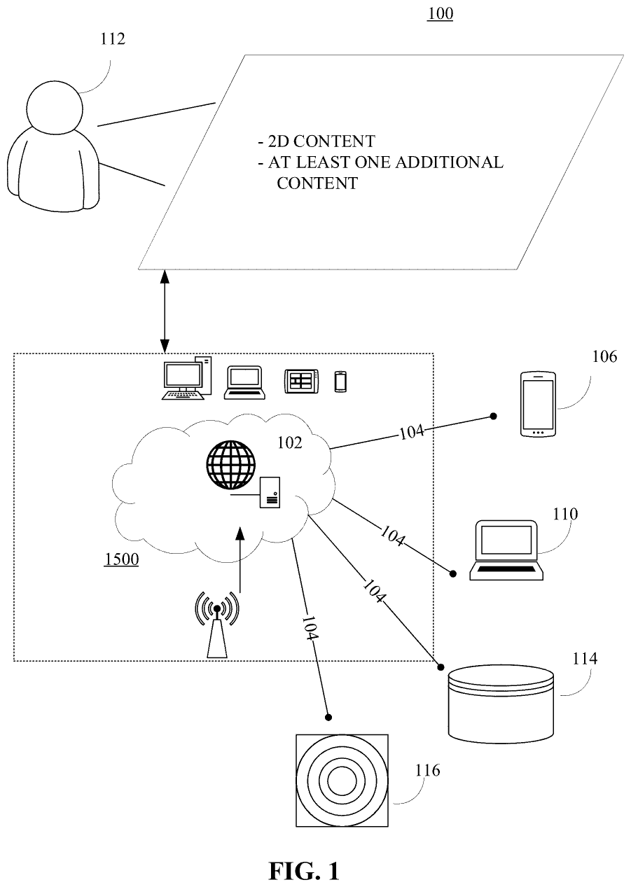

Referring now to figures, FIG. 1 is an illustration of an online platform 100 consistent with various embodiments of the present disclosure. By way of non-limiting example, the online platform 100 to facilitate population of a virtual space around a 2D content may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1500.

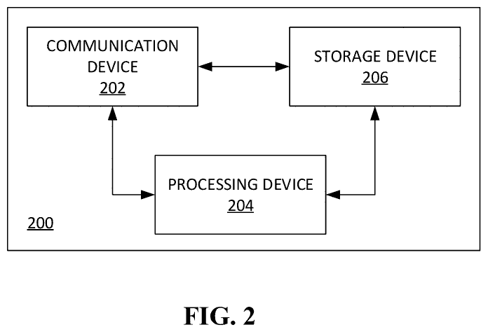

FIG. 2 is a block diagram of a system 200 for facilitating population of a virtual space around a 2D content, in accordance with some embodiments. Accordingly, the system 200 may include a communication device 202 configured for receiving the 2D content from at least one external device. Further, the 2D content may include a 2D video, a 2D audio-video, etc. Further, the at least one external device may include the 2D content. Further, the at least one external device may include a server. Further, the at least one external device may include a computing device such as a laptop, a desktop, a tablet, a smartphone, a smartwatch, and so on. Further, the system 200 may include a processing device 204 communicatively coupled with the communication device 202. Further, the processing device 204 may be configured for analyzing the 2D content. Further, the processing device 204 may be configured for identifying at least one cue in the 2D content based on the analyzing. Further, the processing device 204 may be configured for generating at least one additional content for the 2D content based on the at least one cue. Further, the at least one additional content populates the virtual space around the 2D content. Further, the processing device 204 may be configured for synchronizing the at least one additional content with the 2D content based on the generating. Further, the at least one additional content may be synchronously presentable with the 2D content based on the synchronizing. Further, the system 200 may include a storage device 206 communicatively coupled with the processing device 204. Further, the storage device 206 may be configured for storing the at least one additional content.

Further, in some embodiments, the communication device 202 may be configured for transmitting the at least one additional content and the 2D content to at least one presentation device. Further, the at least one presentation device may include at least one VR headset. Further, the at least one presentation device may be configured for presenting the at least one additional content and the 2D content synchronously. Further, the at least one presentation device may be associated with at least one user. Further, the at least one VR headset may be configured for presenting the at least one additional content and the 2D content synchronously to the at least one user.

Further, in some embodiments, the storage device 206 may be configured for retrieving at least one asset based on the identifying of the at least one cue. Further, the generating of the at least one additional content may be based on the retrieving.

Further, in some embodiments, the communication device 202 may be configured for receiving at least one content element for the at least one cue from at least one device. Further, the at least one device may include a computing device such as a laptop, a desktop, a tablet, a smartphone, a smartwatch, and so on. Further, the processing device 204 may be configured for analyzing the at least one content element. Further, the generating of the at least one additional content may be based on the analyzing of the at least one content element.

Further, in some embodiments, the at least one additional content may include at least one layer. Further, the at least one layer may be characterized by at least one element comprised in the at least one layer.

Further, in some embodiments, the processing device 204 may be configured for analyzing the at least one layer of the at least one additional content. Further, the processing device 204 may be configured for determining at least one position of the at least one layer in the virtual space around the 2D content. Further, the processing device 204 may be configured for positioning the at least one layer in the virtual space around the 2D content based on the determining Further, the synchronizing of the at least one additional content with the 2D content may be based on the positioning. Further, the at least one position corresponds to a foreground position, a background position, etc.

Further, in some embodiments, the at least one additional content may include at least one interactive object. Further, the at least one interactive object may be associated with a plurality of states. Further, the communication device 202 may be configured for receiving at least one input from at least one input device. Further, the at least one input device may be comprised in the at least one VR headset. Further, the at least one input device may include a user interface comprised in the at least one VR headset. Further, the at least one input device may include a computing device such as a laptop, a desktop, a tablet, a smartphone, a smartwatch, and so on. Further, the at least one input device may be configured for generating the at least one input based on at least one gesture made by at least one user associated with the at least one input device. Further, the processing device 204 may be configured for analyzing the at least one input. Further, the processing device 204 may be configured for transitioning the at least one interactive object between the plurality of states. Further, the transitioning may include interacting with the at least one object. Further, the synchronizing of the at least one additional content may be based on the transitioning.

Further, in some embodiments, the analyzing of the 2D content may include performing an image analysis of a visual component of the 2D content. Further, the identifying of the at least one cue may be based on the performing of the image analysis. Further, the at least one cue may include at least one visual cue.

Further, in some embodiments, the analyzing of the 2D content may include performing a sound analysis of an audio component of the 2D content. Further, the identifying of the at least one cue may be based on the performing of the sound analysis. Further, the at least one cue may include at least one audio cue.

Further, in some embodiments, the at least one additional content may be not embedded in the 2D content. Further, the 2D content may not contain the at least one additional content. Further, the 2D content and the at least one additional content may be separably presentable.

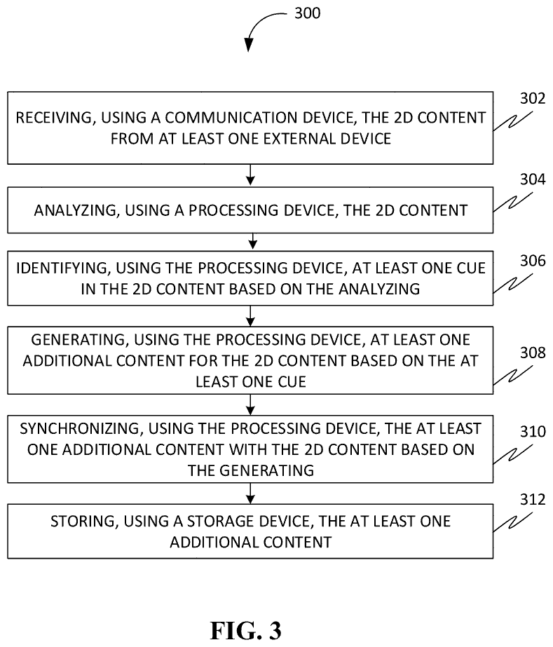

FIG. 3 is a flowchart of a method 300 for facilitating population of a virtual space around a 2D content, in accordance with some embodiments. Accordingly, at 302, the method 300 may include receiving, using a communication device, the 2D content from at least one external device.

Further, at 304, the method 300 may include analyzing, using a processing device, the 2D content.

Further, at 306, the method 300 may include identifying, using the processing device, at least one cue in the 2D content based on the analyzing.

Further, at 308, the method 300 may include generating, using the processing device, at least one additional content for the 2D content based on the at least one cue. Further, the at least one additional content populates the virtual space around the 2D content.

Further, at 310, the method 300 may include synchronizing, using the processing device, the at least one additional content with the 2D content based on the generating. Further, the at least one additional content may be synchronously presentable with the 2D content based on the synchronizing

Further, at 312, the method 300 may include storing, using a storage device, the at least one additional content.

Further, the method 300 may include transmitting, using the communication device, the at least one additional content and the 2D content to at least one presentation device. Further, the at least one presentation device may be configured for presenting the at least one additional content and the 2D content synchronously.

Further, in some embodiments, the at least one additional content may include at least one layer. Further, the at least one layer may be characterized by at least one element comprised in the at least one layer.

Further, the method 300 may include retrieving, using the storage device, at least one asset based on the identifying of the at least one cue. Further, the generating of the at least one additional content may be based on the retrieving.

Further, in some embodiments, the analyzing may include performing an image analysis of a visual component of the 2D content. Further, the identifying of the at least one cue may be based on the performing of the image analysis. Further, the at least one cue may include at least one visual cue.

Further, in some embodiments, the analyzing may include performing a sound analysis of an audio component of the 2D content. Further, the identifying of the at least one cue may be based on the performing of the sound analysis. Further, the at least one cue may include at least one audio cue.

Further, in some embodiments, the at least one additional content may be not embedded in the 2D content.

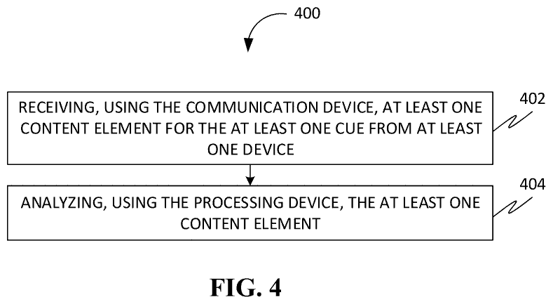

FIG. 4 is a flowchart of a method 400 for analyzing at least one content element for facilitating the population of the virtual space around the 2D content, in accordance with some embodiments. Accordingly, at 402, the method 400 may include receiving, using the communication device, the at least one content element for the at least one cue from at least one device.

Further, at 404, the method 400 may include analyzing, using the processing device, the at least one content element. Further, the generating of the at least one additional content may be based on the analyzing of the at least one content element.

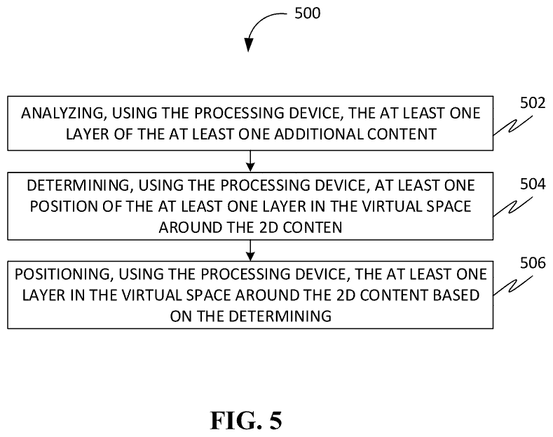

FIG. 5 is a flowchart of a method 500 for positioning the at least one layer in the virtual space around the 2D content for facilitating the population of the virtual space around the 2D content, in accordance with some embodiments. Accordingly, at 502, the method 500 may include analyzing, using the processing device, the at least one layer of the at least one additional content.

Further, at 504, the method 500 may include determining, using the processing device, at least one position of the at least one layer in the virtual space around the 2D content. Further, the at least one position corresponds to a foreground position, a background position, etc.

Further, at 506, the method 500 may include positioning, using the processing device, the at least one layer in the virtual space around the 2D content based on the determining Further, the synchronizing of the at least one additional content with the 2D content may be based on the positioning.

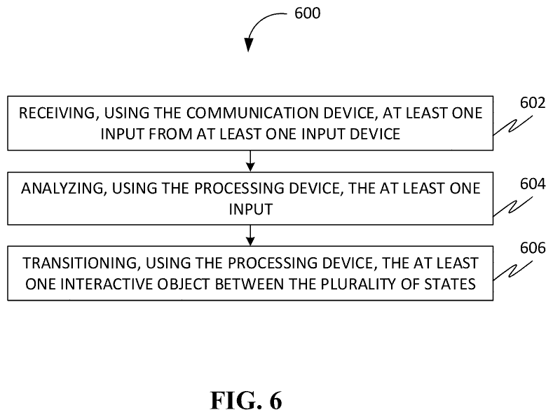

FIG. 6 is a flowchart of a method 600 for transitioning at least one interactive object for facilitating the population of the virtual space around the 2D content, in accordance with some embodiments. Accordingly, the at least one additional content may include the at least one interactive object. Further, the at least one interactive object may be associated with a plurality of states. Further, at 602, the method 600 may include receiving, using the communication device, at least one input from at least one input device.

Further, at 604, the method 600 may include analyzing, using the processing device, the at least one input.

Further, at 606, the method 600 may include transitioning, using the processing device, the at least one interactive object between the plurality of states. Further, the transitioning may include interacting with the at least one object. Further, the synchronizing of the at least one additional content may be based on the transitioning.

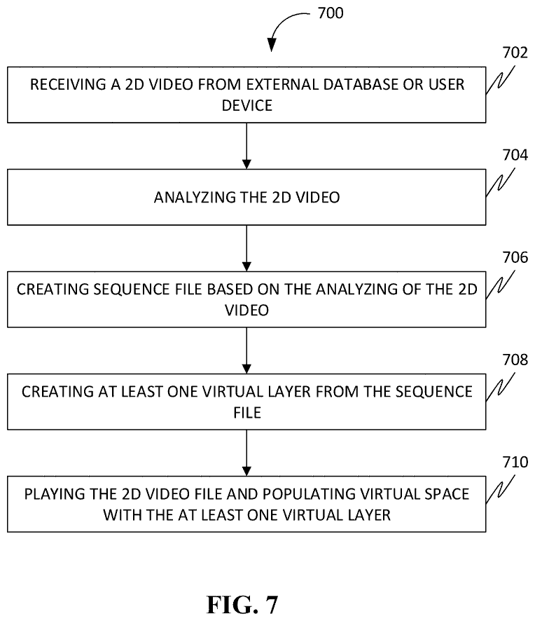

FIG. 7 is a flowchart of a method 700 to facilitate population of virtual space around a 2D video, in accordance with some embodiments. Accordingly, 702, the method 700 may include a step of receiving a 2D video from an external database or device. Further, the 2D video may be received from an external database, such as an online streaming service. Further, the 2D video may be received from a user device. Further, the 2D video may be stored in the memory of the user device and may be received from the user device directly over a communication network such as, but not limited to cellular network, a personal area network, the Internet, and so on. The 2D video may include a movie or an episode of a television show or a cartoon series. Further, the 2D video may include a silent movie, or episode, or maybe with a voice. The 2D video may even be a music video.

Further, at 704, the method 700 may include a step of analyzing the 2D video. Further, the analyzing of the 2D video may be based on a content of the 2D video. Further, the analyzing of the 2D video may be a manual procedure. Further, the 2D video may be analyzed by watching. Further, the analyzing of the 2D video may be based on the visuals, scenes, and sounds. Further, the scenes (or individual scenes) may be watched to analyze the setting, and environment being displayed, and if any special effects may have been used. Further, the 2D video may be analyzed based on a sound. Further, the sound of the 2D video may be analyzed for audio cues that may act as an indication of the scene. For instance, in a movie, if a firefight has broken out, the scene may be analyzed and sounds of guns being shot may be recognized. Alternatively, the analyzing may be automated through machine learning. Further, the 2D video may be analyzed by performing image processing on individual frames of the 2D video and gathering information about the objects that may be present in the individual frames of the 2D video. Further, the 2D video may be analyzed based on sound. Further, the sounds associated with the 2D video may be analyzed and recognized to analyze the individual scenes of the 2D video and gather information about the special effects that may have been used. For instance, the sound of an explosion may be analyzed to determine the special effects for the explosion and fire that may have been used in the 2D video.

Further, at 706, the method 700 may include a step of creating a sequence file based on the analyzing of the 2D video. The sequence file may include an additional data. The sequence file may include a sequence of events associated with the 2D video including information such as, but not limited to the special effects used in the 2D video, audio cues that may aid in recognition of triggering the special effects, the storyline of the 2D video, and so on with respect to the run-time of the 2D video. Further, individual events (or the events) may all be timestamped in accordance with the point of time at which the individual events may be occurring in the 2D video. For instance, if the 2D video is a movie, the sequence file may include a timeline of the movie, along with all the environmental effects that may describe the setting and environment of the individual scenes for example, a scene may take place in a forest environment. Further, the sequence file may include the information of the special effects that may have been used in the movie, along with sound signatures of prominent objects, and the audio cues of important events, such as explosions.

Further, at 708, the method 700 may include a step of the creating at least one virtual layer from the sequence file. Further, the virtual layer may include additional components (or layer) that may complement the 2D video and make the viewing experience more immersive. For instance, the additional layer may include a 3D environment layer. Further, the 3D environment layer may be complementary to the 2D video and may enhance the visual appeal of the 2D video.

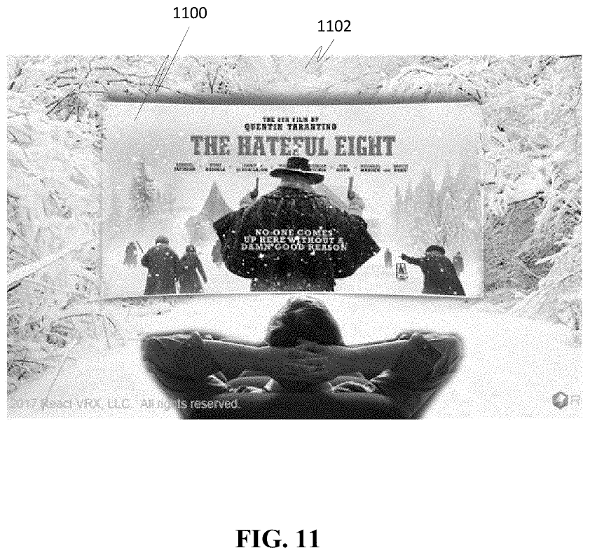

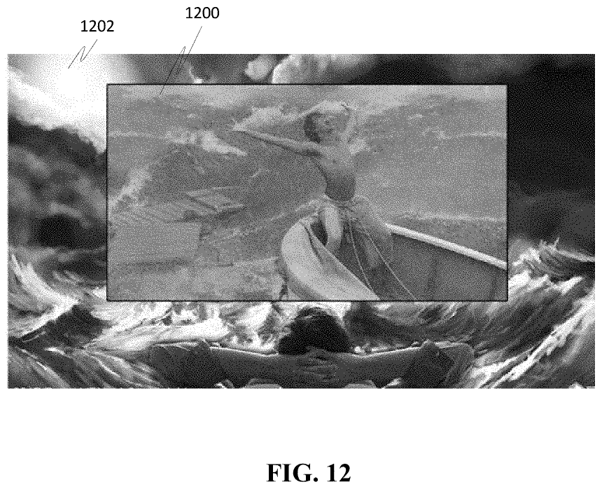

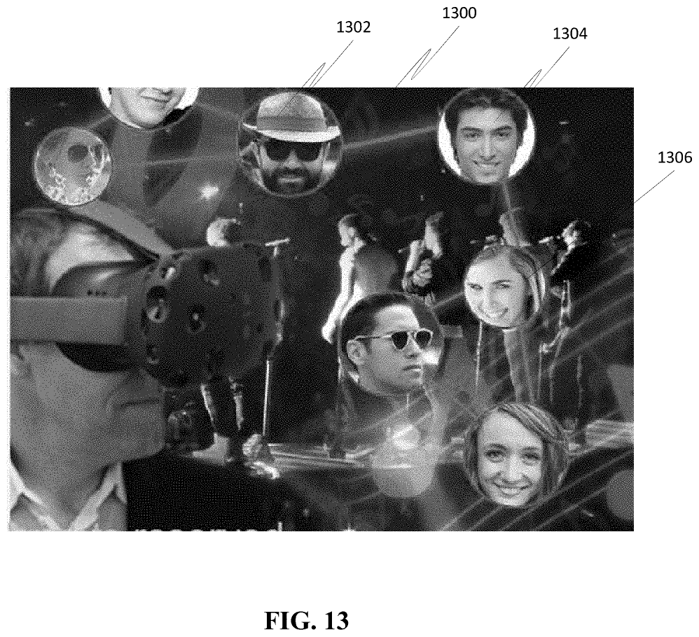

For instance, if the 2D video includes a scene that may transpire in a forest environment, the 3D environment may simulate a forest setting, along with all the environmental effects that may describe the forest setting and environment. Further, as shown in FIG. 11 and FIG. 12, if the movie includes a scene that may transpire in a mountainous environment, including snow, or in a setting that may depict a storm in a sea, the 3D environment layer may include a snowy mountain and a stormy sea setting to enhance the experience of viewing the 2D video. Further, the additional layer may be a social layer. The social layer may include an avatar of the user and the friends of the user that may be viewing the 2D video along with the user. For instance, as shown in FIG. 13, a user may view avatars of other users who may be viewing the 2D video. Further, the 2D content may include the 2D video and the additional content may include the avatars of the other users. Further, the social layer may include elements that may allow interaction between the users that may be viewing the 2D video together. For instance, the social layer may include chat heads that may allow the users to chat with each other through instant messages, video calls, or audio calls, or through interactive emotes, for instance, laugh, cry, or scared. Further, the social layer may be populated with interactive objects that the users may interact with. For instance, the social layer may include objects that the users may throw at each other, like virtual popcorn. Further, the social layer may be dynamic, and may rapidly change based on the interaction of the users.

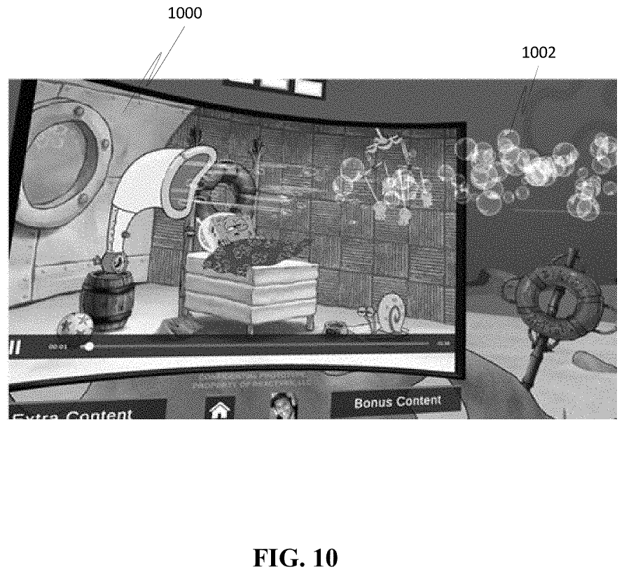

Further, at 710, the method 700 may include a step of playing the 2D video and populating the virtual space with the at least one virtual layer. The 2D video file may be played directly through the source. For instance, if the 2D file is a movie selected from an online streaming service, the movie may be played through the online streaming service. The layers (such as the virtual layers) may include a social layer that may be populated with elements that may allow for interaction between the users, a visual effects data layer that may include added special effects to enhance the special effects that may be present in the movie, a 3D environment layer that may enhance the environment and setting of individual scenes of the movie, and make the virtual space more interactive and immersive, or a combination of any of these layers. Further, the layers may be completely synchronized with the 2D video. For instance, as shown in FIG. 10, the 2D video may include an episode of a cartoon show (such as SpongeBob SquarePants) that may be set in an underwater environment. Further, the 2D video may be populated with a 3D environment layer that may simulate the underwater environment. Further, the 2D video may be populated with a special effects layer that may enhance the viewing experience of the user by adding additional special effects, like bubbles. Further, the 2D video may be populated with a social layer that may allow the user to view and interact with the other users.

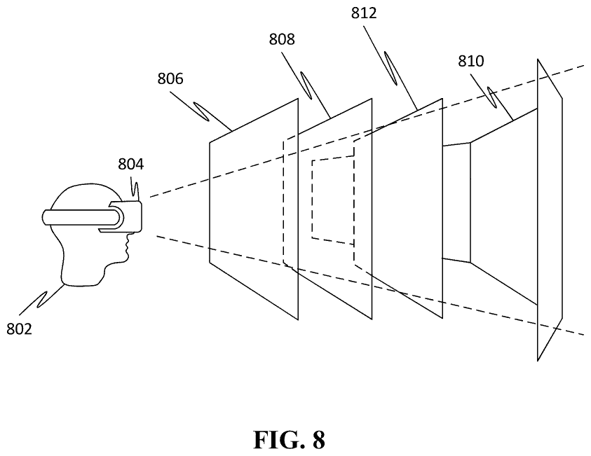

FIG. 8 is an illustration of the layers 806-810 generated by the disclosed system to populate the virtual space around a 2D video 812, in accordance with some embodiments. Accordingly, a user 802 may view the 2D video 812 in an immersive VR environment generated by the disclosed system through a VR headset 804. The layers 806-810 may be stacked in a comprehensive manner to cohesively populate the virtual space around the 2D video 812. The 2D video 812 may be played from the source. The disclosed system may not make any changes in format, visuals, or the audio of the 2D video 812. The layers 806-810 to populate the virtual space around the 2D video 812 may be generated by the disclosed system with regard to the 2D video 812. The layers 806-810 may include a social layer 806 that may be populated with elements that may allow for interaction between the users, a visual effects data layer 808 (or visual FX layer) that may include added special effects to enhance the special effects that may be present in the movie, a 3D environment layer 810 that may enhance the environment and setting of individual scenes of the movie, or a combination of one or more of the layers 806-810. Further, the layers 806-810 may make the virtual space around the 2D video 812 more interactive and immersive. Further, the user 802 may view the 2D video 812 in the immersive VR environment generated by the disclosed system through the VR headset 804.

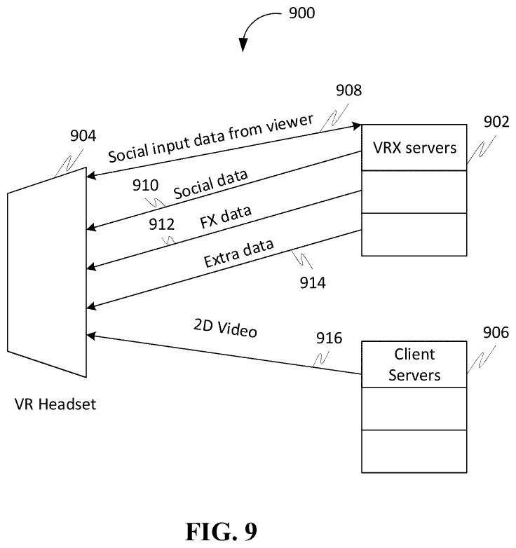

FIG. 9 is a schematic of a system 900 to facilitate the population of virtual space around a 2D video, in accordance with some embodiments. Accordingly, the system 900 (such as VRX) may include an online platform hosted on VRX servers 902 to facilitate the population of virtual space around a 2D video. Further, the system 900 may include a VR headset 904 that may be used by an individual (or user) to access the 2D video from client servers 906, such as a streaming service like Netflix®. Further, at 908, the VR headset 904 may receive social input data from viewers using the VRX servers 902. Further, at 910, the VR headset 904 may receive social data from the VRX servers 902. Further, at 912, the VR headset 904 may receive FX data from the VRX servers 902. Further, at 914, the VR headset 904 may receive extra data from the VRX servers 902. Further, at 916, the VR headset 904 may receive 2D video from the client servers 906. The VR headset 904 may include a display to display the 2D video and additional content. Further, the VR headset 904 may include an audio output device, such as, but not limited to a speaker, or a pair of headphones, or earphones. Further, the VR headset 904 may include a communication device configured to communicate over a communication network such as, but not limited to, a cellular network, a satellite network, a personal area network, Bluetooth, Internet, and so on. Further, the VR headset 904 may include a user interface to allow the user to communicate and interact with the content that may be displayed on the display.

Further, the VR headset 904 may include a processor. Further, the processor may process inputs that may be received from a device associated with the user through the user interface. The 2D video may include a movie or a television show that the user may want to view through the VR headset 904. The user may select the 2D video from the client servers 906. Upon selection of the 2D video, the 2D video may be analyzed by the system 900. The analyzing may include the image analysis of the video that may be performed on the frames of the 2D video. The analysis may further be sound analysis, where all the sounds in the 2D video may be analyzed. Upon completion of the analysis, the system 900 may populate the virtual area surrounding the 2D video with additional content relevant to the 2D video. For instance, if the 2D video is a movie, the additional content may include changes in environment and lighting depending on the scene that may be playing in the movie. The additional content may include extensions of the sets of the movie that may make the movie more immersive. Further, the system 900 may add additional special effects and 3D elements to the movie being played. Further, image and audio processing of the 2D video may trigger the special effects. For instance, the system 900 may recognize the sound of explosions, and gunshots, and may populate the virtual space around the movie with the special effects. Further, the additional content may include storyline reminder videos, pop-ups containing facts, and mini-games, for example, trivia about the movie, favorite show. The additional content may be toggled to be turned on or off. Further, the system 900 may populate the virtual space around the 2D video to allow a social interaction between users through user profiles. Further, the system 900 may allow users to view 2D videos watched previously or currently being watched by friends (or other users). Further, the system 900 may allow the user to watch the 2D video in a VR environment. The user may watch the 2D video that may be sourced from a database. Further, the system 900 may allow the users watching the 2D video sourced from the database to interact with each other. The interaction may be through various means. For instance, the users may interact through instant messages, video calls, or audio calls. Further, the users may view online avatars of the other users that may be watching the same 2D video sourced from the same source. Further, the users may interact with each other through interactive emotes for instance laugh, cry, or scared. The system 900 may also populate the virtual environment with interactive objects that the users may interact with. For instance, the users may throw virtual popcorn at the other users. Further, if the user leaves the virtual environment, the other users may see a “walkout” or teleport effect.

FIG. 10 illustrates a screenshot 1000 of the movie “SpongeBob SquarePants” with additional content 1002, in accordance with some embodiments.

FIG. 11 illustrates a screenshot 1100 of the movie “The Hateful Eight” with additional content 1102, in accordance with some embodiments.

FIG. 12 illustrates a screenshot 1200 of the movie “Life of Pi” with additional content 1202, in accordance with some embodiments.

FIG. 13 illustrates a screenshot 1300 of a 2D content with additional content 1302-1306, in accordance with some embodiments.

FIG. 14 illustrates a screenshot 1400 of the movie “Scarface” with additional content 1402, in accordance with some embodiments.

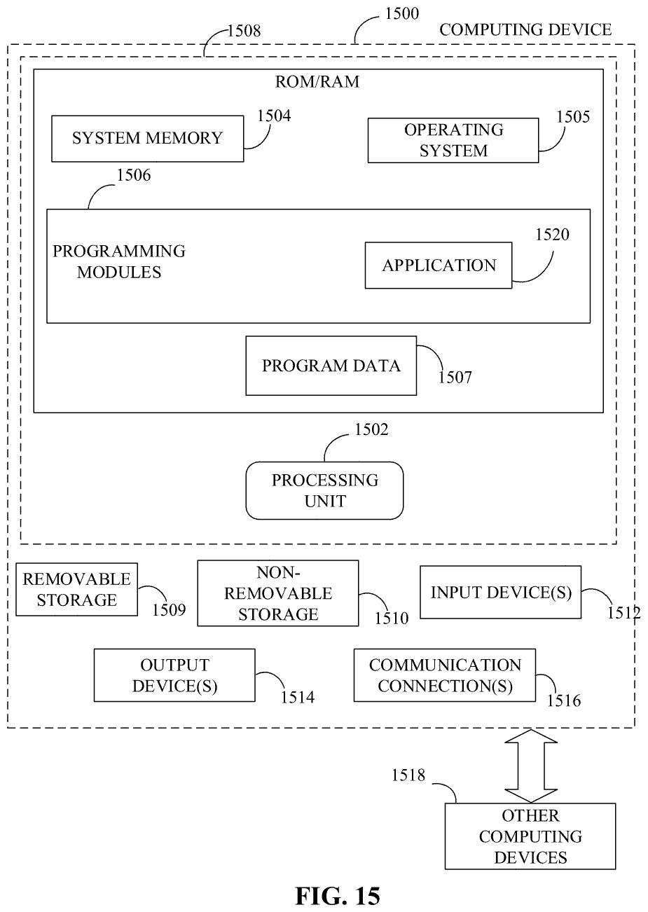

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random-access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500′s operation. In one embodiment, programming modules 1506 may include image-processing module, machine learning module. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and non-volatile, removable and non-removable media implemented in any method or technology for storage of information, such as computer-readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, a location sensor, a camera, a biometric sensor, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., application 1520) may perform processes including, for example, one or more stages of methods, algorithms, systems, applications, servers, databases as described above. The aforementioned process is an example, and processing unit 1502 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for facilitating population of a virtual space around a 2D content, the method comprising:
receiving, using a communication device, the 2D content from at least one external device;
analyzing, using a processing device, the 2D content;
identifying, using the processing device, at least one cue in the 2D content based on the analyzing;
generating, using the processing device, at least one additional content for the 2D content based on the at least one cue, wherein the at least one additional content populates the virtual space around the 2D content;
synchronizing, using the processing device, the at least one additional content with the 2D content based on the generating, wherein the at least one additional content is synchronously presentable with the 2D content based on the synchronizing; and
storing, using a storage device, the at least one additional content.

2. The method of claim 1 further comprising transmitting, using the communication device, the at least one additional content and the 2D content to at least one presentation device, wherein the at least one presentation device is configured for presenting the at least one additional content and the 2D content synchronously.

3. The method of claim 1 further comprising retrieving, using the storage device, at least one asset based on the identifying of the at least one cue, wherein the generating of the at least one additional content is further based on the retrieving.

4. The method of claim 1 further comprising:
receiving, using the communication device, at least one content element for the at least one cue from at least one device; and
analyzing, using the processing device, the at least one content element, wherein the generating of the at least one additional content is further based on the analyzing of the at least one content element.

5. The method of claim 1, wherein the at least one additional content comprises at least one layer, wherein the at least one layer is characterized by at least one element comprised in the at least one layer.

6. The method of claim 5 further comprising:
analyzing, using the processing device, the at least one layer of the at least one additional content;
determining, using the processing device, at least one position of the at least one layer in the virtual space around the 2D content; and
positioning, using the processing device, the at least one layer in the virtual space around the 2D content based on the determining, wherein the synchronizing of the at least one additional content with the 2D content is further based on the positioning.

7. The method of claim 1, wherein the at least one additional content comprises at least one interactive object, wherein the at least one interactive object is associated with a plurality of states, wherein the method further comprises:
receiving, using the communication device, at least one input from at least one input device;
analyzing, using the processing device, the at least one input; and
transitioning, using the processing device, the at least one interactive object between the plurality of states, wherein the transitioning comprises interacting with the at least one object, wherein the synchronizing of the at least one additional content is further based on the transitioning.

8. The method of claim 1, wherein the analyzing comprises performing an image analysis of a visual component of the 2D content, wherein the identifying of the at least one cue is based on the performing of the image analysis, wherein the at least one cue comprises at least one visual cue.

9. The method of claim 1, wherein the analyzing comprises performing a sound analysis of an audio component of the 2D content, wherein the identifying of the at least one cue is based on the performing of the sound analysis, wherein the at least one cue comprises at least one audio cue.

10. The method of claim 1, wherein the at least one additional content is not embedded in the 2D content.

11. A system for facilitating population of a virtual space around a 2D content, the system comprising:
a communication device configured for receiving the 2D content from at least one external device;
a processing device communicatively coupled with the communication device, wherein the processing device is configured for:
analyzing the 2D content;
identifying at least one cue in the 2D content based on the analyzing;
generating at least one additional content for the 2D content based on the at least one cue, wherein the at least one additional content populates the virtual space around the 2D content; and
synchronizing the at least one additional content with the 2D content based on the generating, wherein the at least one additional content is synchronously presentable with the 2D content based on the synchronizing; and
a storage device communicatively coupled with the processing device, wherein the storage device is configured for storing the at least one additional content.

12. The system of claim 11, wherein the communication device is further configured for transmitting the at least one additional content and the 2D content to at least one presentation device, wherein the at least one presentation device is configured for presenting the at least one additional content and the 2D content synchronously.

13. The system of claim 11, wherein the storage device is further configured for retrieving at least one asset based on the identifying of the at least one cue, wherein the generating of the at least one additional content is further based on the retrieving.

14. The system of claim 11, wherein the communication device is further configured for receiving at least one content element for the at least one cue from at least one device, wherein the processing device is further configured for analyzing the at least one content element, wherein the generating of the at least one additional content is further based on the analyzing of the at least one content element.

15. The system of claim 11, wherein the at least one additional content comprises at least one layer, wherein the at least one layer is characterized by at least one element comprised in the at least one layer.

16. The system of claim 15, wherein the processing device is further configured for:
analyzing the at least one layer of the at least one additional content;
determining at least one position of the at least one layer in the virtual space around the 2D content; and
positioning the at least one layer in the virtual space around the 2D content based on the determining, wherein the synchronizing of the at least one additional content with the 2D content is further based on the positioning.

17. The system of claim 11, wherein the at least one additional content comprises at least one interactive object, wherein the at least one interactive object is associated with a plurality of states, wherein the communication device is further configured for receiving at least one input from at least one input device, wherein the processing device is further configured for:
analyzing the at least one input; and
transitioning the at least one interactive object between the plurality of states, wherein the transitioning comprises interacting with the at least one object, wherein the synchronizing of the at least one additional content is further based on the transitioning.

18. The system of claim 11, wherein the analyzing of the 2D content comprises performing an image analysis of a visual component of the 2D content, wherein the identifying of the at least one cue is based on the performing of the image analysis, wherein the at least one cue comprises at least one visual cue.

19. The system of claim 11, wherein the analyzing of the 2D content comprises performing a sound analysis of an audio component of the 2D content, wherein the identifying of the at least one cue is based on the performing of the sound analysis, wherein the at least one cue comprises at least one audio cue.

20. The system of claim 11, wherein the at least one additional content is not embedded in the 2D content.
